(19) United States
(12) Patent Application Publication
(10) Pub. No.: US 2024/0385428 A1
(43) Pub. Date: Nov. 21, 2024

(54) LOW F NUMBER REFRACTIVE TELESCOPE WITH DYNAMIC ALTITUDE COMPENSATION

(71) Applicant: BAE Systems Information and Electronic Systems Integration Inc., Nashua, NH (US)

(72) Inventors: Michael J. Powers, Amherst, NH (US); Matthew W. Grabowski, Nashua, NH (US)

(73) Assignee: BAE Systems Information and Electronic Systems Integration Inc., Nashua, NH (US)

(21) Appl. No.: 18/319,247

(22) Filed: May 17, 2023

(51) Int. Cl. G02B 23/16; G02B 7/02; G02B 27/62; G05D 23/19

(52) U.S. Cl. CPC G02B 23/16; G02B 7/021; G02B 27/62; G05D 23/1931

(57) ABSTRACT

A system and method are disclosed for a low F-number precision variable-focus telescope that includes a telescope housing containing an optical system. There is a first temperature sensing device to detect a temperature of the telescope housing, a second temperature sensing device to detect an ambient temperature around the telescope housing, and a pressure sensing device to detect ambient pressure around the telescope housing. A controller is in operative communication with the first temperature-sensing device, the second temperature sensing device, and the pressure sensing device. The control regulates the heater to maintain the telescope at a desired temperature to achieve diffraction limited performance in response to signals from the first temperature-sensing device, the second temperature sensing device, and the pressure sensing device.

### TECHNICAL FIELD

The present disclosure relates generally to refractive telescopes.

### BACKGROUND ART

Traditional telescopes rely on the use of multiple lenses to achieve the desired magnification and clarity. However, variations in temperature can cause these lenses or the housing that retains the lenses to expand or contract, resulting in changes in the focal length of the telescope and thereby degrading the image quality. Athermalization is the process of designing an optical system to minimize the effects of temperature changes on its performance.

Refractive telescopes can be designed to be athermal (i.e., insensitive to temperature) by carefully selecting the optical glass and telescope housing materials so that their temperature dependent properties self-cancel as the telescope temperature changes. These properties include the change in refractive index with temperature (dn/dT) and the coefficient of thermal expansion (CTE) of the housing and lens materials.

The “f-number” (sometimes referred to as F-number or f#) is the ratio of focal length to aperture diameter. Here, a “low” f-Number is one considered to be a f-number value of 2 or less. Compact telescope designs with low f-number are challenging for an athermalization technique since they can become highly sensitive to lot-to-lot variations in the change in refractive index with temperature (i.e., dn/dT) and the coefficient of thermal expansion (i.e., the CTE) material properties. This variation can require material characterization of every lot during manufacture.

One method to counteract refractive telescopes sensitivity to ambient temperature is through the addition of a heater, which reduces the range of telescope temperatures by always keeping the telescope hot or at least warm (at about 50° C.) when exposed to ambient temperatures. Stated otherwise, in the current state of the art, refractive telescopes with low f-numbers can be heated or maintained at about 50° C. so they are maintained as constant, albeit hot, temperature. The use of a heater maintains the telescope at this static temperature.

Low f-number refractive telescopes are also sensitive to ambient air pressures and altitudes since the air refractive index varies from approximately n=1.0003 at sea level approaching a value of n=1 at high altitudes and space vacuum applications. This complicates ground testing and operations due to focus differences between ground and operational altitudes of the system.

The current methods for compensating for these effects include attempting to athermalize the telescope by balancing the dn/dT and CTE effects of the glass and housing materials. To do this for a Low F-number refractive telescope, a designer often has to match sets of material properties and geometries of optics and housings that are complex and expensive. This is easier to match with High F-number (i.e., f-number greater than 2) telescopes, but the matching comes at the expense of larger size and mass telescopes (i.e., increases size, weight, power and cost considerations). Further, they use CTE matched housing materials with the glass or lens material, which are typically heavy & poor thermal conductivity (e.g. Invar, Titanium) or expensive (e.g. Beryllium alloys). Additionally, they may include mechanical motion (e.g. piezo flexure or motor driven) focus adjustment techniques to adjust spacing between lenses, which are complex and take up space and weight.

### SUMMARY OF THE INVENTION

Prior systems or prior telescopes that would use a heater to maintain the telescope at a constant hot temperature have the drawbacks discussed above. For example, there is still temperature sensitivity because the body or housing of the telescope may not be one uniform temperature due to thermal gradients from the front to the back of the telescope even though it is being heated. Given the drawbacks of the current state of the art for refractive variable focus telescopes, especially low F-number refractive telescopes, a need continues to exist for a refractive variable focus telescope that is optimized for sensitivity to temperature for heating compensation of altitude defocus. The present disclosure address this need, amongst other needs, and provides a low F-number refractive variable focus telescope with dynamic altitude compensation by accounting for ambient air altitude (or pressure) and optionally accounting for ambient air temperature.

According to one exemplary aspect of an embodiment of the present disclosure, a preexisting or a legacy heater that is on an afocal telescope can be utilized with an improved system architecture or computer program product that re-optimizes the entire design to take advantage of the fact that the heater is present. This exemplary system of the present disclosure utilizes software to control the heater to maintain the temperature at a desired operating temperature. This enables the system of the present disclosure to use a software controller that knows the ambient pressure and altitude (from sea level to space) and knows the ambient environmental temperature. The altitude/pressure and temperature are used to calculate what temperature the telescope shall be maintained to compensate for those temperatures and altitude/pressures. In addition to dynamically controlling the temperature of the housing of the telescope, an embodiment of the present disclosure utilizes a housing of the telescope of the present disclosure that includes a material with an increased coefficient of thermal expansion. Recall, previous designs of afocal telescopes used housing materials, such as titanium, that balanced the change in optical behaviors of the glass. However, titanium has a coefficient of thermal expansion that is fairly close to the coefficient of thermal expansion of the glass forming the triplet pair of optics. In order to dynamically control the temperature with software to adjust the focus of the telescope across the temperature range that is desired, the system of the present disclosure is able to provide greater control of the focus relative to temperature. Stated otherwise, the amount of focus for every degree of temperature that is shifted can be controlled. In order to accomplish this, the present disclosure utilizes a specific material with higher coefficient of thermal expansion than the previous usage of titanium. One such material that should suffice is aluminum. This higher CTE provides, for a given temperature change, the ability to precisely change the focus more than what was previously able to be accomplished with a titanium housing. Stated otherwise, by heating or controlling the temperature of the housing the physical housing expands and contracts to alter the spacing distance between the first pair of optics and the second pair of triplet optics.

The embodiments disclosed herein should achieve diffraction limited performance (≤±¼ waves of defocus) over a wide temperature and altitude environment by compensating the high sensitivity to ambient pressure by importing at least some of or all of the following features: a housing material with a high coefficient of thermal expansion (CTE) for high focus sensitivity to temperature, which results in a wide dynamic range of defocus compensation (e.g. Aluminum); a housing material with a high thermal conductivity, which results in low thermal gradients when heater power is applied allowing for accurate temperature measurement and low gradients when parts of the telescope are exposed to different ambient temperatures (e.g. Aluminum); a pair of triplet lenses (i.e, three lenses defining a first set of lenses from the pair and three lenses defining a second set of lenses from the pair) with low intra-pair sensitivity to temperature, which results in keeping higher order optical aberrations (non-focus) under control over wide temperature ranges; a telescope temperature sensor is used to monitor the telescope body temperature for closed loop control of the heater power; an ambient pressure sensor that is used as feedback for telescope temperature setpoint control to compensate for defocus from sea level to >100 kft or more (i.e., space); and an ambient temperature sensor that is used as feedback for telescope setpoint control for corrections related to ambient temperatures.

Some embodiments of the present disclosure enable provide a compact 50 mm aperture, 5× magnification, afocal SWIR telescope. Some of these embodiments provide a faster thermal response over prior systems which allow the system of the present disclosure to achieve full performance over a larger temperature and altitude operational envelope. Some embodiments provide for rapid dynamic focusing adjustment, which enables: significantly expanded performance operating envelope (altitude and temperature) for the system; significant reduction in testing time and calibration required of supply base and factory, providing cost and schedule improvements; yield improvements by reducing tight dependence of custom precision housing dimensions with matched sets of optics; and the elimination of time constraints on system operation for telescope warmup periods which speeds factory testing and operational timelines in the field.

In one exemplary aspect, an embodiment of the present disclosure may provide a method comprising: sensing, with a first temperature sensing device, a temperature of a telescope housing, wherein the telescope housing comprises an interior and an exterior, wherein the telescope housing interior contains an optical element, wherein optical element in the telescope housing is associated with an F-number, and wherein the F-number is less than or equal to 2; sensing, with a pressure sensing device, an ambient pressure around the telescope housing; and regulating, with a controller that is in operative communication with the first temperature sensing device and the pressure sensing device, a heater that is coupled directly or indirectly to the telescope housing to achieve diffraction limited performance of the optical element in response to signals from the first temperature-sensing device and the pressure sensing device.

In another exemplary aspect, an embodiment of the present disclosure may provide a low F-number precision variable-focus telescope comprising: a telescope housing comprising an interior and an exterior, wherein the telescope housing interior contains an optical element, wherein optical element in the telescope housing is associated with an F-number, and wherein the F-number is less than or equal to 2; a heater coupled directly or indirectly to the telescope housing; a first temperature sensing device to detect a temperature of the telescope housing; a pressure sensing device to detect ambient pressure around the telescope housing; a controller in operative communication with the first temperature-sensing device and the pressure sensing device; wherein the controller regulates the heater to maintain the telescope at a desired temperature to achieve diffraction limited performance in response to signals from the first temperature-sensing device and the pressure sensing device.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a side elevation view of an exemplary low F-number telescope according to one embodiment of the present disclosure.

FIG. 2 (FIG. 2) is a longitudinal cross section view of the exemplary low F-number telescope taken along line 2-2 in FIG. 1.

FIG. 3 (FIG. 3) is an exemplary diagrammatic chart representative of the exemplary low F-number telescope according to one embodiment of the present disclosure.

FIG. 4 (FIG. 4) is a flow chart depicting an exemplary method or process according to one embodiment of the present disclosure.

FIG. 5 (FIG. 5) is a graph depicting defocus difference versus lens F-number at various altitudes.

FIG. 6A (FIG. 6A) is a graph depicting the performance of defocus over time for a telescope of the present disclosure and a conventional telescope along an exemplary flight path.

FIG. 6B (FIG. 6B) is a graph depicting the altitude versus pressure for the exemplary flight path shown in FIG. 6A.

Similar numbers refer to similar parts throughout the drawings.

### DETAILED DESCRIPTION

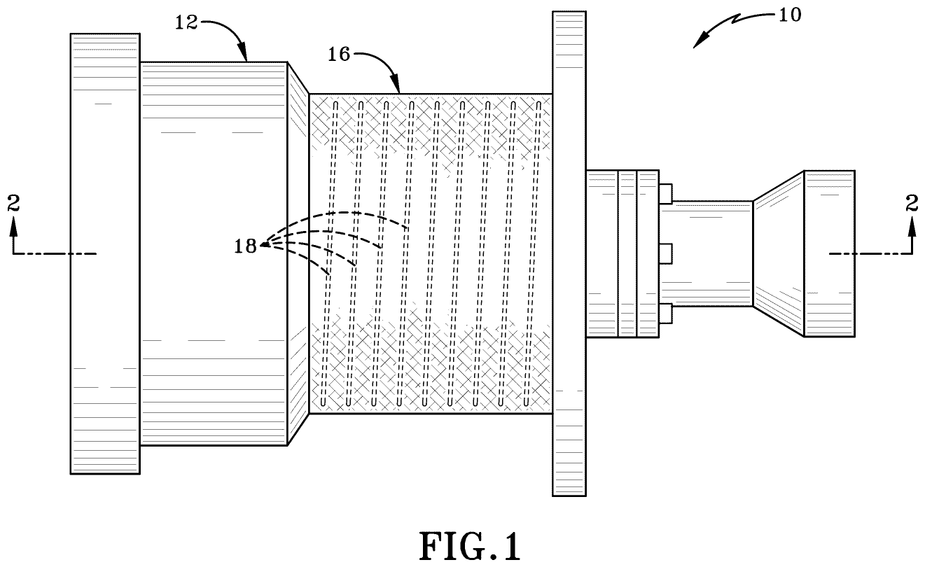

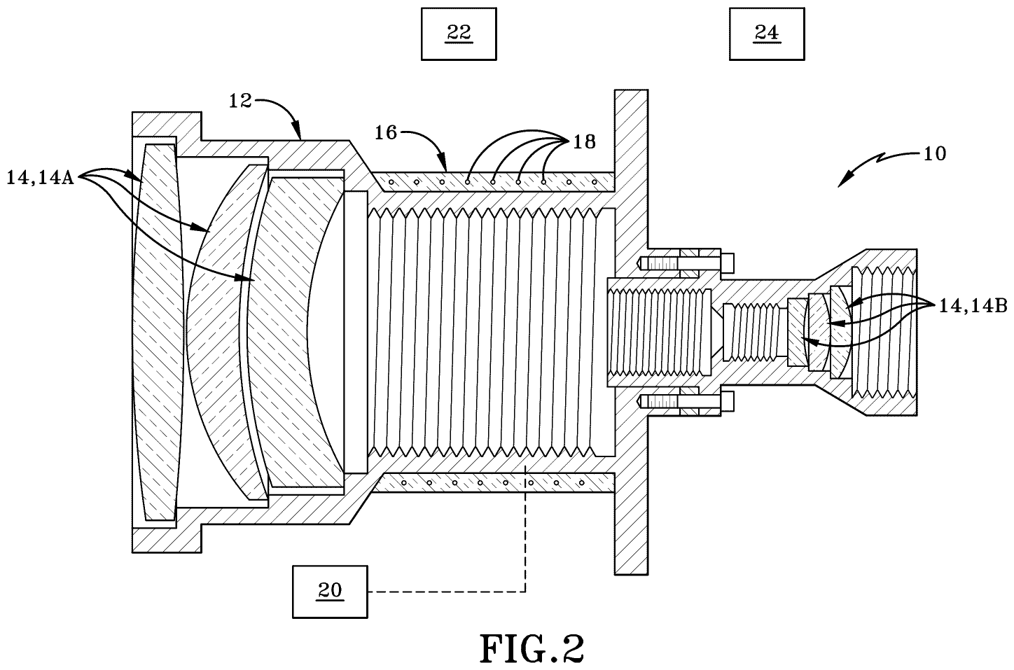

FIG. 1 and FIG. 2 depict a telescope with a f-number that is 2 or less. Thus, as used herein the term “low f-number” refers to an optical system or assembly with a f-number less than 2. In one embodiment, a low f-number telescope is a variable-focus telescope 10. Telescope 10 includes a housing 12 and one or more optical lenses 14. In one embodiment, the optical lenses 14 include a pair of triplet lens 14A, 14B. By way of example, the telescope housing 12 may be comprised of aluminum. The material selected to form the housing 12 of the telescope 10 should also have a high thermal conductivity. Thus, aluminum may be a desirable material to utilize when constructing the housing 12 because it has a high level of thermal conductivity as well as a high CTE. The high level of thermal conductivity reduces the likelihood of thermal gradient across the body of housing 12 of the telescope 10.

A heat spreader 16 is attached or coupled to the telescope housing 12 either directly or indirectly. In one embodiment, the heat spreader 16 surrounds at least a portion of the telescope housing 12. Additionally, the heat spreader 16 may be contiguous with the periphery of the telescope housing 12. The heat spreader 16 may be one piece in one embodiment. In another embodiment, the heat spreader 16 may be machined in at least two parts. The heat spreader 16 parts may be connected or coupled by any suitable method, including but not limited to, screws, adhesives, and welds. By way of example, the heat spreader 16 may be comprised of aluminum.

In one embodiment, the heat spreader 16 is wrapped around the outside of the central barrel of housing 12 of the telescope 16. In one embodiment, the heat spreader 16 may be a foil-based heater (including heater 18 or heater elements) that is conformal to the outer surface of the central barrel of the housing in between the pair of triplet optics 14A, 14B. Given the placement of the heat, if the material has a low level of thermal conductivity, then the central portion of the telescope would be warmer and the outer ends where the triplet optics are located would be cooler. Thus forming the housing 12 from a material with high thermal conductivity results in low gradients to establish temperature uniformity across the entirety of the body forming the telescope while allowing the heater to be utilized only in the central portion thereof. Another material that would be useful for forming the housing of the telescope with a relatively high CTE and a relatively high thermal conductivity would be copper.

In one embodiment, at least one heater 18 is attached to the heat spreader 16 to regulate temperature of the precision variable-focus telescope 10. The heater 18 can be spread along sections of the heat spreader 16 and in patterns such as strips or rows to allow for effective heating. In one embodiment, the heater 18 is an electric-resistance heater that is contiguous with the heat spreader 16 via the foil or film. The electric-resistance heater 18 has a resistance element to evenly heat the heat spreader 16. By way of example, the electric-resistance heater 18 may be comprised of polyimide foil. In one embodiment, the electric-resistance heater 18 is attached to the heat spreader 16 by pressure-sensitive adhesive. The composition of the adhesive should not interfere with the heating of the heat spreader 16. Other attachment mechanisms of the film heater 18 to the heat spreader 16 include screws, pins and posts. In another embodiment, the heat spreader 16 may be eliminated and the heater 18 may simply connected to or wrapped around the housing 12 of telescope 10. For example, when the housing 12 of telescope 10 is manufactured with a sufficiently high CTE and a sufficiently high thermal conductivity, as in greater detail described herein, the heat spreader may be eliminated and the heater 18 is connected directly to or wrapped around in direct contact with housing 12 of telescope.

FIG. 2 depicts a cross-sectional view of the low f-number precision variable-focus telescope 10 that has a telescope housing 12 and optics 14. In one embodiment, a gap pad may be sandwiched between the telescope housing 12 and the heat spreader 16. The gap pad fills in the empty space between the heat spreader 16 and telescope housing 12 to evenly heat the telescope housing 10. In various embodiments, the gap pad may be contiguous with the telescope housing 10 and the heat spreader 16. By way of example, the gap pad may be comprised of a material with a low thermal impedance to transfer heat from the heat spreader 16 to the telescope housing 10.

FIGS. 1-3 depict that at least one temperature-sensing device 20 is attached or coupled to the heat spreader 16 either directly or indirectly. Device 20 may be considered as a first temperature sensing device 20. The temperature-sensing device 20 may also be mounted elsewhere on the telescope. The temperature-sensing device 20 measures the temperature of the telescope 10. By way of example, the temperature-sensing device 20 may comprise a thermistor. In one example the temperature-sensing device 20 is located away from the heater 18. In another example, there are multiple temperature-sensing devices 20. According to one embodiment a temperature calibration table may be used such as a temperature of the telescope 10 is or any location thereof is established by knowing the temperature at the temperature-sensing device 20.

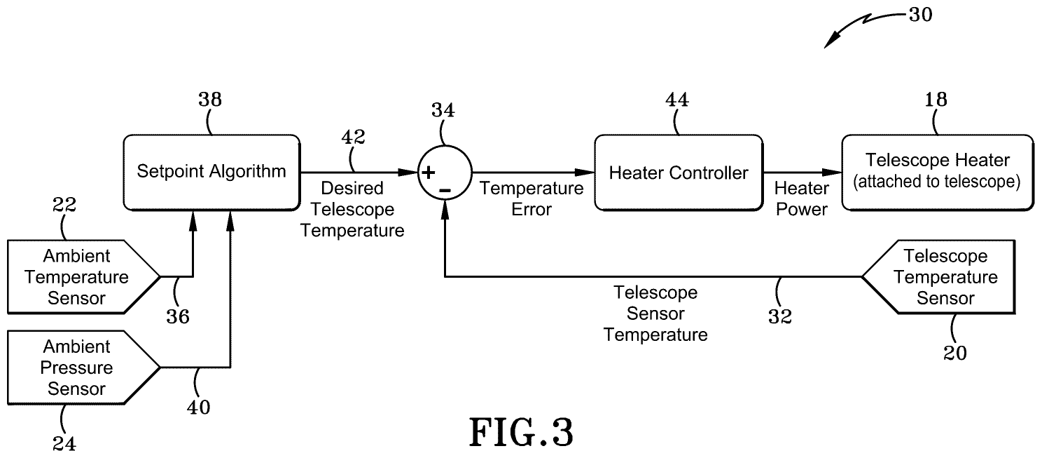

The first temperature sensing device 20 is operatively coupled with the heater (see also FIG. 3). The first temperature sensing device 20 has an output that is processed in a manner so as to control the heater. Software, protocols, instructions or other logic is in operative communication with the temperature sensor to maintain the telescope 10 at the desired temperature. One particular temperature that would be useful for maintaining the telescope in a desired operating temperature range would be within plus or minus 5% of 50 degrees Celsius. The software controls the amount of power provided to the heater to regulate the desired temperature. Control of the heater power is accomplished through a closed loop control. A closed loop control refers to a temperature sensor on the telescope that measure the temperature of the telescope. That temperature or data is provided to a PID control loop (proportional integrator derivative control loop) that generates feedback to regulate the heater power to the heater on the telescope to always maintain the temperature sensor at a desired set point. Thus, the loop between the temperature sensor and the heater power is closed.

The system or telescope 10 also includes a second temperature sensing device 22 that is adjacent the telescope 10 and measures ambient temperature of the volume of air or space near or proximate the exterior of telescope 10. In one embodiment, the second temperature sensing device 22 is composed of a single sensor. In another particular embodiment, the system of the present disclosure utilizes sensors as part of the second temperature sensing device 22 to detect ambient temperatures near the telescope. Specifically, this embodiment may utilize three separate ambient temperature sensors which collectively define the second temperature sensing device 22, wherein a first ambient temperature sensor detects ambient temperature near the front end of the telescope 10, an intermediate ambient temperature sensor that detects the ambient temperature near the middle of the telescope 10, and a third ambient temperature sensor that detect the ambient temperature near a second end of the telescope 10. The ambient temperature sensors that may collectively define the second temperature sensing device 22 detect the ambient temperature to identify three different temperature zones around the telescope 10. The ambient temperatures may be averaged across their respective values, or they may be used independently in the processing to control heater 18 as discussed herein.

A pressure sensor 24 is adjacent the telescope 10 and measures ambient pressure of the volume of air or space near the exterior of telescope 10. The pressure sensor 24 could alternatively be an altimeter inasmuch as the pressure is mostly directly related to altitude.

FIGS. 3 depicts one exemplary embodiment of a precision variable-focus telescope heating mechanism control loop 30. The first temperature-sensing device 20 attached to the heat spreader 16 or another portion of the housing 12 of telescope 10 measures the temperature of the telescope 10. The second temperature sensing device 22 is adjacent the telescope 10 and measures ambient temperature of the volume of air or space near the exterior of telescope 10. The pressure sensor 24 is adjacent the telescope 10 and measures ambient pressure of the volume of air or space near the exterior of telescope 10.

The temperature feedback 32 from the first temperature sensing device 20 is an input to temperature digitization electronics that converts the temperature feedback or signal to a reading that can be processed. Temperature feedback 32 is transmitted to a summation block 34.

The temperature feedback 36 from the second temperature sensing device 22 is an input to temperature digitization electronics that converts the temperature feedback 36 or signal to a reading that can be processed. Temperature feedback 36 is transmitted to a temperature setpoint algorithm or temperature setpoint logic 38.

The ambient pressure feedback 40 from the pressure sensing device 24 is an input to temperature digitization electronics that converts the pressure feedback or signal to a reading that can be processed. Pressure feedback 40 is transmitted to the temperature setpoint algorithm or temperature setpoint logic 38.

Temperature setpoint logic 38 determines what temperature that the telescope 10 or telescope housing 12 should operate to optimize the diffraction limited performance (≤±¼ waves of defocus) over a wide temperature and altitude environment. This allows the telescope 10 having a low f-number to compensate for the high sensitivity to ambient pressure and ambient temperature.

Regarding the set point logic 38, one exemplary embodiment has only ambient temperature input (from second temperature sensing device 22), whereas another embodiment has both ambient pressure input (from pressure device 24) and ambient temperature sensor input. Thus, in some embodiments, the ambient pressure sensor input is optional to setpoint logic 38. In some embodiments, the ambient temperature sensor input is optional to setpoint logic 38, such that it only uses the ambient pressure. Further, other embodiments enable setpoint logic 38 to use a multitude of pressure and temperature sensor inputs if there are large gradients around the telescope. For example if the ambient temperatures around each end of the telescope are different, it may be advantageous to have readings of both zones to calculate optimal setpoint temperature for focus of the telescope 10. Setpoint logic 38 may include a look-up table to determine the best setpoint temperature for focus of the telescope based on ambient pressure and temperature readings. Setpoint logic may perform a method to use the look-up table to determine the best setpoint temperature for focus of the telescope based on ambient pressure and temperature readings. Setpoint logic 38 may interpolate between points in the look-up table. The setpoints in the look-up table temperature setpoints may be determined by calibration testing over ambient temperatures and pressures of the telescope or a representative telescope while measuring focus of the telescope.

In an alternative configuration, rather than the look-up table, the setpoint logic 38 may utilize an equation used with coefficients similarly determined by fitting calibration test data to a formula. For example, “Setpoint temperature=A*(Ambient Temperature)+B*(Ambient Pressure)+C” where the equation and A,B,C are coefficients determined by the telescope design. A, B, C values would be based on best fit of equation to the calibration data.

The output 42 of setpoint logic 38, which is the desired telescope temperature, is transmitted to summation block 34. Summation block 34 receives, as an input to the summation block 34, the output 42 of setpoint logic 38. Also, summation block 34 receives, as an input to the summation block 34, the temperature feedback 32 from first temperature sensing device 20.

The output of the summation block 34 is an input to the telescope temperature input control or controller 44. Controller 44 may be coupled to a sample rate count, which outputs the reading from both temperature sensors 20, 20 as a 12-bit telescope temperature, respectively. The 12-bit telescope temperature may be an input to a 1—a filter unit that applies filter gain. The filtered telescope temperatures may be an input to the heater controller 44. In one example, the controller 44 is a Proportional/Integral controller (PID controller) implemented within a controller such as a Field Programmable Gate Array (FPGA). A temperature calibration table is used in one embodiment to provide a more precise temperature for the telescope 10.

The output of the PID controller 44 feeds the heater input to a switching power supply. By way of example, the switching power supply may be a “buck” (step-down), “boost,” “buck-boost,” “isolated,” or “non-isolated” switching power supply. This switching power supply regulates the voltage across the heater 18, which may be an electric film heater that applies the heat energy to the heat spreader 16 thereby, maintaining the telescope 10 at a desired temperature to achieve diffraction-limited performance. In one embodiment, the temperature set-point for the control loop 30 is “user-settable” through a digital interface.

In another example, the output of the PID controller 44 feeds the heater input to a linear power supply of the heater 18. This linear power supply regulates the voltage across the heater 18, which may be an electric film heater, and controls the power applied by the electric film heater, thereby maintaining the telescope 10 at a desired temperature to achieve diffraction-limited performance.

FIG. 3 depicts the heater power into the heater 18 that surrounds the telescope 10. There is another temperature sensor (telescope middle housing) that detects the temperature of the telescope in the middle thereof. This temperature sensor (i.e., device 20) measures what the temperature of the middle of the telescope is at a certain time. That temperature signal is sent to a summation block. The data from the middle temperature sensor is summed in the summation block with the set point temperature that the system wants to hold the telescope. The summation block generates an error signal if the measured temperature does not equal the set point temperature. Stated otherwise, if the temperature sensor data equals the set point temperature then there is no error output from the summation block. The error signal, when present, enters the PID control loop, which is a proportional controller. The proportional controller is generating a signal to the heater to tell the heater how much power is needed to warm the telescope to the desired level of the set point temperature. This process loops and repeats until there is no more error signal. For example, if the set point temperature is below the registered temperature detected from the temperature sensor at the middle of the housing, then instructions will be sent by the PID controller to turn off the power so the telescope cools down. Alternatively, if the temperature detected by the middle temperature housing is below the set point temperature, then the PID controller will increase power to the heater in order to warm the telescope. This, there is a feedback loop such that this process is continuous to continuously warm or cool the telescope to maintain the telescope at the desired set point temperature.

The system of the present disclosure is an improvement over prior telescopes that used static or fixed temperatures to maintain the telescopes at a preset temperature. In these previous systems or device, there was no feedback loop that allowed responsive changes to be made to the heater based on the temperature of the telescope or based on altitude. This was limiting because it only permitted the telescope to be focused at a certain range of altitudes. By adding the feedback loop and the PID controllers of the present disclosure, the system utilizing the telescope with this improved technique allows a greater range of altitudes and temperatures to be utilized while maintaining the low f-number telescope to be usable at those broader ranges of altitudes and pressures. The set point calculator also obtains pressure data from a pressure sensor and calculates the pressure as a function of temperature or in relation to temperature. By measuring pressure in conjunction with the temperature, the set point calculator can determine the best focus for the telescope given the temperature and pressure parameters. This can be calculated via a look up table or a pre-calibrated measurements or alternatively can be adaptively learned through artificial intelligence.

It should be noted that the control loop can take many different forms and the PID of controller 44 disclosed herein is not required in every embodiment of controller 44. However, a PID has been found to be reliable and efficient for the purposes disclosed herein. Thus, the PID can be one portion of the control loop, but PID is not required so long as the control loop still accounts for temperature and pressure to dynamically power the heater element around or on the telescope in order to maintain the defocus of the telescope within the desired target range.

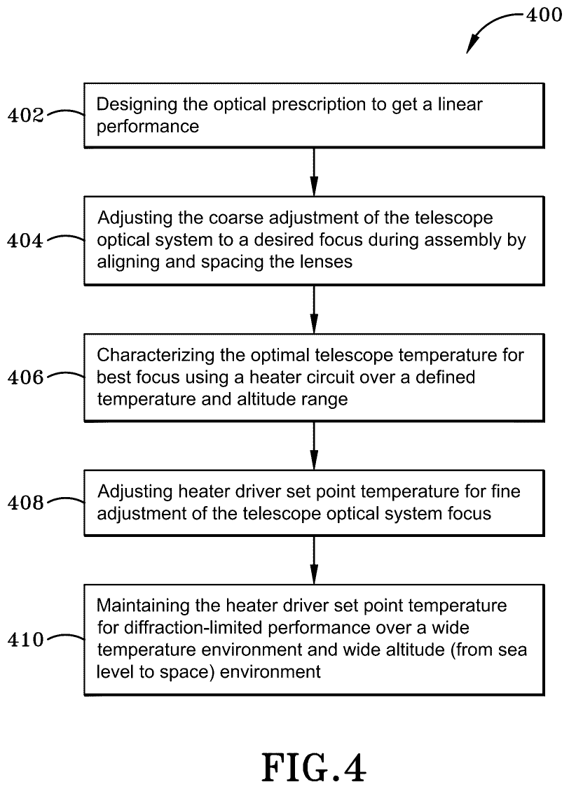

FIG. 4 depicts a method for focusing the optical system in a low F-number precision variable-focus telescope according to one embodiment, shown generally at 400. This method 400 in this example includes designing the optical prescription to get a linear performance, which is shown generally at 402. The method also includes adjusting the coarse adjustment of the telescope optical system to a desired focus during assembly by aligning and spacing the lenses, which is shown generally at 404. The method further comprises characterizing the optimal telescope temperature for best focus using a heater circuit over a defined temperature and altitude range, which is shown generally at 406. The method may further comprise adjusting heater driver set point temperature for fine adjustment of the telescope optical system focus, which is shown generally at 408. The method includes maintaining the heater driver set point temperature for diffraction-limited performance over a wide temperature environment and wide altitude (from sea level to space) environment, which is shown generally at 410.

In one embodiment, initial (coarse) adjustment of the desired focus utilizes a traditional method of adjusting and setting of lens optics within the telescope housing 10 while the telescope is heated to an initial value. The method further includes adjusting the heater driver set point temperature for fine adjustment of the telescope optical system, which is shown generally at 406. In one embodiment, fine (precision) adjustment of focus is accomplished by modifying the temperature of the telescope until diffraction-limited performance is achieved. The precision adjustment of focus of modifying the temperature of the telescope until diffraction-limited performance is accomplished by using feedback 32 from the first temperature sensing device 20, feedback 36 from the ambient second temperature sensing device 22, and optionally feedback 40 from the ambient pressure sensing device 24. In various embodiments, the range of temperature used to adjust the focus is greater than the maximum environmental temperature of the air surrounding the telescope 10. The constant heat flow into the telescope 10 eliminates the need to use cooling to maintain temperature.

In one embodiment, the telescope 10 of the present disclosure is an afocal telescope in which a collimated beam enters the first end of the telescope at the first pair of triplet lenses that focus the light to a focal point. From the focal point, the light expands to the second pair of triplet lenses. The light ten transmits through the second pair of triplet lenses to exit the second end of the afocal telescope in a smaller diameter collimated beam. The focal length is fairly short compared to the diameter of the optic lenses. This results in the low F-number.

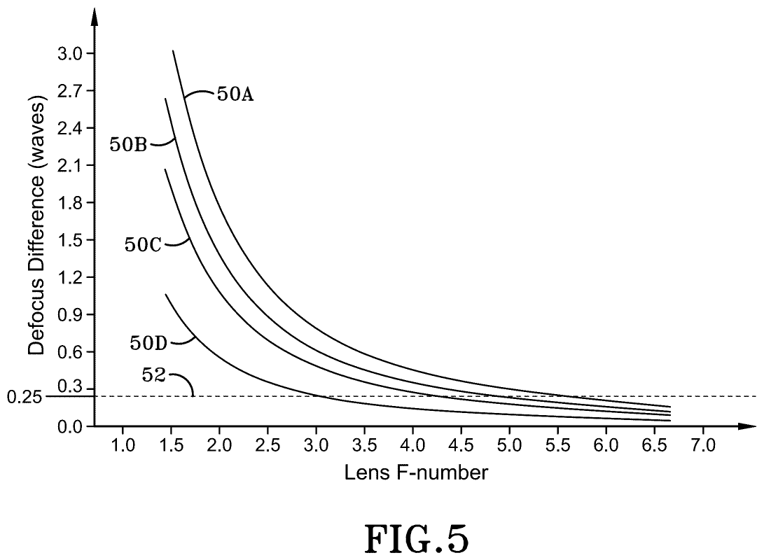

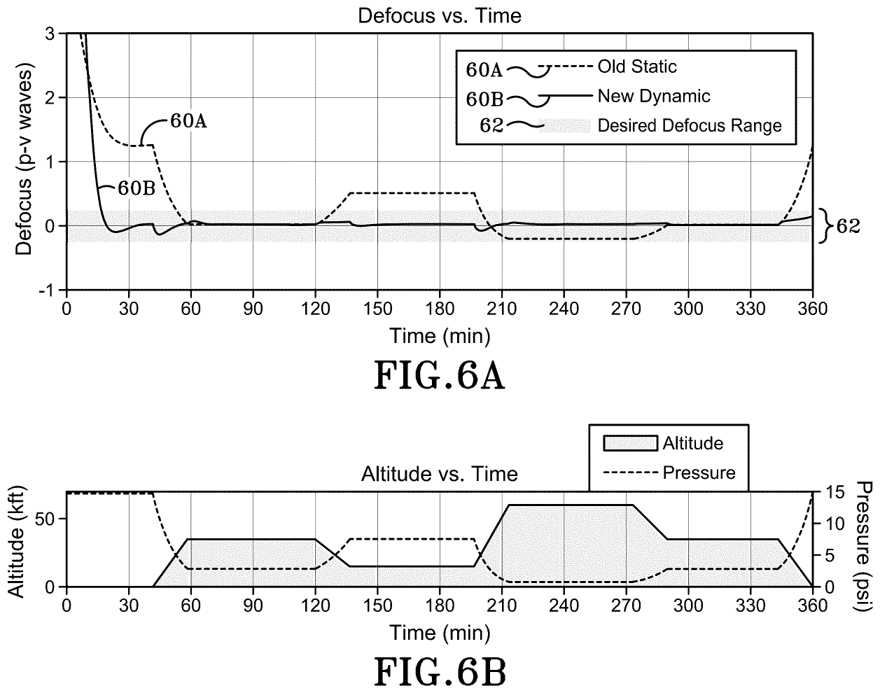

As depicted in FIG. 5, as the f-number decreases for a given telescope, the telescope becomes more sensitive to the refractive index of air or the medium. FIG. 5 plots the difference in defocus between sea level and different altitude examples versus the lens F-number. Line 50A represents the defocus difference between sea level for a conventional telescope located in space or extremely high altitudes (>100,000 Feet). Line 50D represents the defocus difference from sea level for a conventional telescope located at 10,000 feet. Lines 50B and 50C represent two intermediate altitudes located between sea level and outer space. As shown by the lines 50A-50D, even at low altitudes, for low f-number lenses, the defocused difference is high (i.e., above the known defocus limited threshold limit of 0.25. The graph of FIG. 5 also indicates that the defocus limit of 0.25 (shown by dashed line 52) is the general accepted rule of thumb for sharp focus. As will be shown below in FIG. 6A, the telescope 10 of the present disclosure is able to achieve operation below the defocus limit of 0.25 (wherein the +/− range of 0.25 is shown as defocus range 62) based on the structural configurations detailed in FIGS. 1-3 and the operations detailed in FIGS. 3-4.

FIG. 6A and FIG. 6B are graphs indicative of a defocus calculation based on the telescope 10 utilizing second temperature sensing device 22 and the pressure sensing device 24. The defocus calculations model the residual defocus of the system. FIG. 6B depicts a flight profile of a platform (which may be manned or unmanned) that changes altitudes over time. For example, as altitude increases pressure decreases. For example, at time zero the altitude is at its lowest point ant the pressure is at its highest point. As altitude increases over time the pressure decreases.

FIG. 6A identifies the calculated the amount of defocus the telescope 10 has as the temperature in the telescope is controlled utilizing both the first temperature sensing device 20, the second temperature sensing device 22, and the pressure sensing device 24. FIG. 6A depicts that the target defocus p-v waves should be in defocus range 62 that is +/− 0.25 waves. The results graphed in FIG. 6A the dynamic feedback loop controlled temperature system for the telescope 10 yield desirable results to maintain the telescope within the target defocus range 62 better that previous static systems. For example at time zero, the heater 18 is not yet turned on and all systems are relatively defocused. However, as time increases the dynamic feedback loop controlled temperature system for the telescope 10 rapidly brings the telescope 10 within to the defocused target range by heating the telescope as evidenced by line 60B being located within range 62. Then, once the heater 18 warms up the telescope 10, the telescope 10 is better focused. In the old systems or conventional telescopes where the temperature was a static value, there is never a focused value of the telescope when the platform carrying the system is on the ground. This is shown by the line 60A of the old static telescope leveling at point to a value of about 1.25 on the defocus vertical scale.

Line 60B indicates that the temperature on the telescope 10 is being set to its desired temperature prior to the platform leaving the ground based on the ambient temperatures and pressures being sent to the controller 44. As shown in this exemplary graph, the platform carrying the telescope takes off or starts its flight path at about 45 minutes. The temperature of the telescope 10 is constantly changing as sensed by the first and second temperature sensing devices 20, 22 and pressure sensing device 24. However, the dynamically controlled system allow the telescope 10 to maintain and remain within the target defocus band range 62 throughout the flight pattern as evidenced by line 60B. This is shown in distinction to the old static systems, represented by line 60A, which may leave the defocused target range when the altitude and pressures vary. For example, which respect to the old static design, at time T120, the platform begins to decrease its altitude which thereby increases pressure. The old design exits the target defocus range 62 or band between about time T135 to about time T195 (wherein the time is represented by the capital letter T preceding the time on the X-axis of the graph in FIG. 6A-6B). However, over this same timeframe from T135 to T195, the new system of telescope 10 is able to maintain the defocus within the target band range 62 as altitude and pressure of the flight path change, as evidenced by line 60B in range 62 from time T135 to time T195.

Although the present disclosure has described the telescope housing 12 as being formed from aluminum in one embodiment, other embodiments can use different materials to form housing 12. However, these other embodiments should select a material that has a sufficiently high CTE value. For example, as stated previously, it was determined that titanium, which has a CTE value of about 9 was too low for the desired purpose of a low f-number (i.e., f-number less than or equal to 2) precision variable-focus telescope. Thus, other materials that should be used to form the telescope housing 12 should have a CTE value greater than 9. One other embodiment determined that copper, which has a CTE value of about 16 is sufficient to improve performance of a titanium housing. Thus, other materials that could be used to form the telescope housing 12 should have a CTE value greater than 16. Some exemplary other materials that have a CTE value greater than 9 which might be utilized to form housing 12, according to other embodiments of the present disclosure, are identified below in Table 1.

TABLE 1

| | Linear Coefficient |
|---|---|
| | of Thermal Expansion |
| Material | (10⁻⁶ m/(m ° C.)) |
| Steel | 10.8-12.5 |
| Scandium | 10.2 |
| Terbium | 10.3 |
| Yttrium | 10.6 |
| Cast Iron Gray | 10.8 |
| Cement, Portland | 11 |
| Promethium | 11 |
| Inconel | 11.5-12.6 |
| Holmium | 11.2 |
| Hastelloy C | 11.3 |
| Iron, forged | 11.3 |
| Sandstone | 11.6 |
| Terne | 11.6 |
| Palladium | 11.8 |
| Beryllium | 12 |
| Cobalt | 12 |
| Iron, pure | 12.0 |
| Thorium | 12 |
| Lanthanum | 12.1 |
| Erbium | 12.2 |
| Samarium | 12.7 |
| Nickel | 13.0 |
| Bismuth | 13-13.5 |
| Concrete | 13-14 |
| Thulium | 13.3 |
| Uranium | 13.4 |
| Monel metal | 13.5 |
| Gold | 14.2 |
| Steel Stainless Austenitic (310) | 14.4 |
| Constantan | 15.2-18.8 |
| Gold - platinum | 15.2 |
| Gold - copper | 15.5 |
| Steel Stainless Austenitic (316) | 16.0 |
| Copper | 16-16.7 |
| Vinyl Ester | 16-22 |
| Cupronickel 30% (constantan) | 16.2 |
| Phosphor bronze | 16.7 |
| Plaster | 17 |
| Bronze | 17.5-18 |
| Steel Stainless Austenitic (304) | 17.3 |
| Copper, Beryllium 25 | 17.8 |
| Gunmetal | 18 |
| Brass | 18-19 |
| Manganin | 18.1 |
| German silver | 18.4 |
| Silver | 19-19.7 |
| Speculum metal | 19.3 |
| Fluorspar, CaF₂ | 19.5 |
| Kapton | 20 |
| Tin | 20-23 |
| Barium | 20.6 |
| Aluminum | 21-24 |
| Polycarbonate - glass fiber-reinforced | 21.5 |
| Bakelite, bleached | 22 |
| Manganese | 22 |
| Calcium | 22.3 |
| Strontium | 22.5 |
| Duralumin | 23 |
| Nylon, glass fiber reinforced | 23 |
| Magnalium | 23.8 |
| Polyester - glass fiber-reinforced | 25 |
| Solder lead-tin, 50%-50% | 25 |
| Magnesium | 25-26.9 |
| Magnesium alloy AZ31B | 26 |
| Ytterbium | 26.3 |
| Antimonial lead (hard lead) | 26.5 |
| Lead | 29 |
| Thallium | 29.9 |
| Cadmium | 30 |
| Wood, across (perpendicular) to grain | 30 |
| Zinc | 30-35 |
| ABS -glass fiber-reinforced | 31 |
| Polypropylene - glass fiber-reinforced | 32 |
| Indium | 33 |
| Europium | 35 |
| Epoxy - glass fiber reinforced | 36 |
| Polyphenylene - glass fiber-reinforced | 36 |
| Tellurium | 36.9 |
| Selenium | 37 |
| Acetal - glass fiber-reinforced | 39 |
| Plastics | 40-120 |
| Rock salt | 40.4 |
| Benzocyclobutene | 42 |
| Epoxy, cast resins & compounds, unfilled | 45-65 |
| Lithium | 46 |
| Plutonium | 47-54 |

In addition to sufficiently high CTE value discussed above, the material used for housing 12 should also have a sufficiently high thermal conductivity value. For example, as stated previously, it was determined that titanium, which has a thermal conductivity value, at 0° C., of about 22.4 W/m K was too low for the desired purpose of a low F-number (i.e., F-number less than or equal to 2) precision variable-focus telescope. Thus, other materials that should be used to form the telescope housing 12 should have a thermal conductivity value greater than that of titanium. One other embodiment determined that copper, which has a thermal conductivity value, at 0° C., of about 401 W/m K is sufficient to improve performance of a titanium housing. Thus, other materials that could be used to form the telescope housing 12 should have a thermal conductivity value greater than about 100. Some exemplary other materials that have a thermal conductivity value greater than about 100 which might be utilized to form housing 12, according to other embodiments of the present disclosure, are identified below in Table 2.

TABLE 2

| | | Thermal |
|---|---|---|
| | Temperature | Conductivity |
| | - t - | - k - |
| Metal, Metallic Element or Alloy | (° C.) | (W/m K) |
| Aluminum | −73 | 237 |
| Aluminum | 0 | 236 |
| Aluminum | 127 | 240 |
| Aluminum | 327 | 232 |
| Aluminum | 527 | 220 |
| Aluminum - Duralumin (94-96% Al, | 20 | 164 |
| 3-5% Cu, trace Mg) | | |
| Aluminum - Silumin (87% Al, 13% Si) | 20 | 164 |
| Aluminum alloy 3003, rolled | 0-25 | 190 |
| Aluminum alloy 2014. annealed | 0-25 | 190 |
| Aluminum alloy 360 | 0-25 | 150 |
| Beryllium | −73 | 301 |
| Beryllium | 0 | 218 |
| Beryllium | 127 | 161 |
| Beryllium | 327 | 126 |
| Beryllium | 527 | 107 |
| Cadmium | −73 | 99.3 |
| Cadmium | 0 | 97.5 |
| Cadmium | 127 | 94.7 |
| Chromium | −73 | 111 |
| Chromium | 0 | 94.8 |
| Chromium | 127 | 87.3 |
| Chromium | 327 | 80.5 |
| Chromium | 527 | 71.3 |
| Chromium | 727 | 65.3 |
| Chromium | 927 | 62.4 |
| Cobalt | −73 | 122 |
| Cobalt | 0 | 104 |
| Cobalt | 127 | 84.8 |
| Copper | −73 | 413 |
| Copper | 0 | 401 |
| Copper | 127 | 392 |
| Copper | 327 | 383 |
| Copper | 527 | 371 |
| Copper | 727 | 357 |
| Copper | 927 | 342 |
| Copper, electrolytic (ETP) | 0-25 | 390 |
| Copper - Admiralty Brass | 20 | 111 |
| Copper - Aluminum Bronze (95% Cu, | 20 | 83 |
| 5% Al) | | |
| Copper - Bronze (75% Cu, 25% Sn) | 20 | 26 |
| Copper - Brass (Yellow Brass) (70% Cu, | 20 | 111 |
| 30% Zn) | | |
| Copper - Cartridge brass (UNS C26000) | 20 | 120 |
| Copper - Constantan (60% Cu, 40% Ni) | 20 | 22.7 |
| Copper - German Silver (62% Cu, 15% | 20 | 24.9 |
| Ni, 22% Zn) | | |
| Copper - Phosphor bronze (10% Sn, | 20 | 50 |
| UNS C52400) | | |
| Copper - Red Brass (85% Cu, 9% Sn, | 20 | 61 |
| 6% Zn) | | |
| Gold | −73 | 327 |
| Gold | 0 | 318 |
| Gold | 127 | 312 |
| Gold | 327 | 304 |
| Gold | 527 | 292 |
| Gold | 727 | 278 |
| Gold | 927 | 262 |
| Iridium | −73 | 153 |
| Iridium | 0 | 148 |
| Iridium | 127 | 144 |
| Iridium | 327 | 138 |
| Iridium | 527 | 132 |
| Iridium | 727 | 126 |
| Iridium | 927 | 120 |
| Magnesium | −73 | 159 |
| Magnesium | 0 | 157 |
| Magnesium | 127 | 153 |
| Magnesium | 327 | 149 |
| Magnesium | 527 | 146 |
| Magnesium alloy AZ31B | 0-25 | 100 |
| Molybdenum | −73 | 143 |
| Molybdenum | 0 | 139 |
| Molybdenum | 127 | 134 |
| Molybdenum | 327 | 126 |
| Molybdenum | 527 | 118 |
| Molybdenum | 727 | 112 |
| Molybdenum | 927 | 105 |
| Red brass | 0-25 | 160 |
| Rhodium | −73 | 154 |
| Rhodium | 0 | 151 |
| Rhodium | 127 | 146 |
| Rhodium | 327 | 136 |
| Rhodium | 527 | 127 |
| Rhodium | 727 | 121 |
| Rhodium | 927 | 115 |
| Silver | −73 | 403 |
| Silver | 0 | 428 |
| Silver | 127 | 420 |
| Silver | 327 | 405 |
| Silver | 527 | 389 |
| Silver | 727 | 374 |
| Silver | 927 | 358 |
| Tungsten | −73 | 197 |
| Tungsten | 0 | 182 |
| Tungsten | 127 | 162 |
| Tungsten | 327 | 139 |
| Tungsten | 527 | 128 |
| Tungsten | 727 | 121 |
| Tungsten | 927 | 115 |
| Zinc | −73 | 123 |
| Zinc | 0 | 122 |
| Zinc | 127 | 116 |
| Zinc | 327 | 105 |

Although the sensing devices 20, 22, and 24 have been detailed herein, the telescope 10 or its associated system or assembly may additionally include one or more other sensor to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; other temperature sensors sensing machine or motor temperature, ambient air temperature, and environmental temperature; and moisture Sensors sensing surrounding moisture levels.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wifi, ZigBee, MiWi, Bluetooth) for communication. In one example, each of the devices, assemblies, or systems of the present disclosure may have its own IP address and may communicate directly with a router or gateway. This would typically be the case if the communication protocol is WiFi.

In another example, a point-to-point communication protocol like MiWi or ZigBee is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A low F-number precision variable-focus telescope comprising:
a telescope housing comprising an interior and an exterior, wherein the telescope housing interior contains an optical element, wherein the optical element in the telescope housing is associated with an F-number, and wherein the F-number is less than or equal to 2;
a heater coupled directly or indirectly to the telescope housing;
a first temperature sensing device to detect a temperature of the telescope housing;
a pressure sensing device to detect pressure proximate the telescope housing;
a controller in operative communication with the first temperature-sensing device and the pressure sensing device;
wherein the controller regulates the heater to maintain the telescope housing at a desired temperature to maintain diffraction limited performance in response to signals from the first temperature-sensing device and the pressure sensing device.

2. The low F-number precision variable-focus telescope of claim 1, further comprising:
a second temperature sensing device to detect an temperature proximate the telescope housing;
wherein the controller is in operative communication with the first temperature-sensing device, the second temperature sensing device, and the pressure sensing device and the controller regulates the heater to maintain the telescope housing at a desired temperature to achieve diffraction limited performance in response to signals from the first temperature-sensing device, the second temperature sensing device, and the pressure sensing device.

3. The low F-number precision variable-focus telescope of claim 2, further comprising:
a summation device in operative communication with the first temperature sensing device, the second temperature sensing device, and the pressure sensing device, wherein the summation device is in operative communication with the controller; and
wherein the controller includes a proportional/integral controller (PID controller) comprising an input and output; and
a linear power supply comprising an input and output, wherein the input of the linear power supply receives the output signal from the PID controller; wherein the linear power supply output regulates the voltage across the heater and controls the power applied to the heater to maintain the telescope at the desired temperature.

4. The low F-number precision variable-focus telescope of claim 1, further comprising:
a heat spreader comprising a first side and a second side, wherein the second side of the heat spreader is coupled to at least a portion of the exterior of the telescope housing; and
wherein the heater is coupled directly to the heat spreader.

5. The low F-number precision variable-focus telescope of claim 4, further comprising:
a gap pad disposed between the exterior of the telescope housing and the heat spreader.

6. The low F-number precision variable-focus telescope of claim 1, wherein the telescope housing comprises a material having a coefficient of thermal expansion (CTE) value that is greater than 9.

7. The low F-number precision variable-focus telescope of claim 6, wherein the CTE value is greater than 16.

8. The low F-number precision variable-focus telescope of claim 1, wherein the telescope housing comprises aluminum.

9. The low F-number precision variable-focus telescope of claim 1, wherein the telescope housing comprises a material having a thermal conductivity value, at 0° C., that is greater than 100 W/m K.

10. The low F-number precision variable-focus telescope of claim 1, wherein the heater is an electric heater that comprises a polyimide foil.

11. A method comprising:
sensing, with a first temperature sensing device, a temperature of a telescope housing, wherein the telescope housing comprises an interior and an exterior, wherein the telescope housing interior contains an optical element, wherein the optical element in the telescope housing is associated with an F-number, and wherein the F-number is less than or equal to 2;
sensing, with a pressure sensing device, apressure proximate the telescope housing; and
regulating, with a controller that is in operative communication with the first temperature sensing device and the pressure sensing device, a heater that is coupled directly or indirectly to the telescope housing to maintain diffraction limited performance of the optical element in response to signals from the first temperature-sensing device and the pressure sensing device.

12. The method of claim 11, further comprising:
sensing, with a second temperature sensing device, temperature proximate the telescope housing, wherein the controller is in operative communication with the first temperature-sensing device, the second temperature sensing device, and the pressure sensing device and the controller;
regulating the heater to maintain the telescope housing at a desired temperature to achieve diffraction limited performance in response to signals from the first temperature-sensing device, the second temperature sensing device, and the pressure sensing device.

13. The method of claim 12, further comprising:
summing, in a summation device, the signals from the first temperature-sensing device, the second temperature sensing device, and the pressure sensing device, wherein the summation device is in operative communication with the controller;
transmitting an output from the summation device to the controller, wherein the controller includes a proportional/integral controller (PID controller) comprising an input and output;
receiving the output from the PID controller into a linear power supply comprising an input and output; and
regulating, via the linear power supply, a voltage across the heater to control power applied to the heater to maintain the telescope housing at the desired temperature.

14. The method of claim 11, further comprising:
observing an optical prescription of the telescope to obtain a linear performance thereof;
adjusting a coarse adjustment of the telescope to a desired focus;
adjusting a setpoint temperature for fine adjustment of the telescope;
modifying the temperature of the telescope until diffraction-limited performance is achieved, wherein modifying the temperature is accomplished by using feedback from the first temperature sensing device and feedback from the second temperature sensing device.

15. The method of claim 14, wherein modifying the temperature is further accomplished by using feedback from an ambient pressure sensing device.

16. A computer program product including least one non-transitory computer readable storage medium on a moving platform in operative communication with a computer processing unit (CPU) in an optical system having a housing, a first temperature sensing device to sense temperature of the housing, a second temperature sensing device to sense ambient temperature around the housing, and a pressure sensing device to sense ambient pressure around the housing, and a heater coupled directly or indirectly to the housing, the storage medium having instructions stored thereon that, when executed by the CPU, implement a process to maintain the housing at a desired temperature to achieve diffraction limited performance in response to signals from the first temperature sensing device, the second temperature sensing device, and the pressure sensing device, the instructions comprising:
determine the housing temperature with the first temperature sensing device;
determine temperature proximate the housing with the second temperature sensing device;
determine pressure proximate the housing with the pressure sensing device; and
maintain the housing temperature at the desired temperature in response to feedback from the first temperature sensing device, the second temperature sensing device, and the pressure sensing device.

17. The computer program product of claim 16, wherein the instructions further comprise:
sum, in a summation device, signals from the first temperature-sensing device, the second temperature sensing device, and the pressure sensing device, wherein the summation device is in operative communication with the controller;
transmit an output from the summation device to the controller, wherein the controller includes a proportional/integral controller (PID controller) comprising an input and output;
receive the output from the PID controller into a linear power supply comprising an input and output; and
regulate, via the linear power supply, a voltage across the heater to control power applied to the heater to maintain the telescope at the desired temperature.

18. The computer program product of claim 17, wherein the instructions further comprise:
observe an optical prescription of the telescope to obtain a linear performance thereof;
adjust a coarse adjustment of the telescope to a desired focus;
adjust a setpoint temperature for fine adjustment of the telescope; and
modify the temperature of the telescope until diffraction-limited performance is achieved, wherein modifying the temperature is accomplished by using feedback from the first temperature sensing device and feedback from the second temperature sensing device.
